(19) United States
(12) Patent Application Publication
(10) Pub. No.: US 2019/0216022 A1
(43) Pub. Date: Jul. 18, 2019

(54) LIGHT SOURCE WITH PROGRAMMABLE SPECTRAL IRRADIANCE AND CLOSED LOOP CONTROL

(71) Applicant: The Governors of the University of Alberta, Edmonton (CA)

(72) Inventor: Michael Thomas TASCHUK, Edmonton (CA)

(21) Appl. No.: 16/331,434

(22) PCT Filed: Sep. 8, 2017
(86) PCT No.: PCT/CA2017/051063

§ 371 Date: Mar. 7, 2019

Related U.S. Application Data
(60) Provisional application No. 62/385,393, filed on Sep. 9, 2016.

(51) Int. Cl. A01G 7/04; H05B 33/08; H05B 37/02; A01G 9/20

(52) U.S. Cl. CPC A01G 7/045; A01G 9/20; H05B 37/0218; H05B 33/0872

(57) ABSTRACT

The invention includes methods and systems of optimizing plant growth where the quantity and quality of ambient light received by a plant is measured, the difference between the measured ambient light and an optimized target spectral irradiance is determined, and a light source is adjusted to provide supplemental light in a quantity and quality to achieve the target spectral irradiance. A light source may include a plurality of LEDs, configured to have a combined output which is adjustable for frequency and intensity and a radiometer for measuring ambient light. The light source further includes a control system which receives the output of the radiometer, determines the difference between the ambient spectral irradiance and a target spectral irradiance, and causes the plurality of LEDs to emit supplemental light substantially equal to the difference. A lighting system may include separate light sources and radiometers for different zones, allowing for separate and customized control for each zone.

### FIELD OF THE INVENTION

The present invention relates to a light source with programmable spectral irradiance and a closed loop control system for varying the light source to achieve a target spectral irradiance.

### BACKGROUND

Light sources have found application in greenhouses, indoor agriculture, growth chambers and research laboratories. Light emitting diodes (LEDs) offer many advantages over conventional light sources, including long life time, high efficiency, and electronic control. The bandgap of the semiconductor material used in a LED determines the emission wavelengths it emits, providing a wide range colors for different applications. There have been numerous scientific reports of LED lighting for plants, including Bula (1991) which described the use of red LEDs to grow lettuce. Multiple LED colors for plant research are reported in Folta (2005), which uses a red, green and blue LEDs to study plant development and which also predicts the possibility of mimicking sunlight by adding LEDs at different wavelengths until a high quality match can be achieved.

In the prior art, there has been much effort on keeping light output stable in time and in wavelength. For example, U.S. Pat. Nos. 5,334,916, 6,495,964, and application No. 2006/0018118A1 teach methods to stabilize the wavelength and intensity output of LED lighting using temperature control, rapidly time-varying intensity and direct measurement of output intensity respectively. However, LED lifetimes and quality, along with manufacturing knowledge have produced LEDs with stability lifetimes measured in the tens of thousands of hours. For a greenhouse application, one quantity of interest is the daily light integral or DLI, corresponding to the integrated light that plants are exposed to on a daily basis. Each species has a target range needed in order to be healthy. In a greenhouse environment, the dominant source of DLI variation is sunlight intensity itself. For example, FIG. 1 (prior art) compares observed and expected solar irradiance for one day at a site in Brazil reported in Gu (2001). Intraday variations are well above 75%, indicating the importance of rapid, on-site measurement and control of greenhouse lighting.

Along with DLI, it has long been understood that light quality, or the spectral distribution of light, is also of importance. Warrington (1976) demonstrated the importance of the ratio of blue and red light for four plant species, showing light induced differences in plant size, relative proportions of leaves and stems, growth rates, and chemical composition. The importance of controlling spectral irradiance at different points in a plants lifecycle was also reported in Eskins (1996), who report that the morphology and taste of lettuce leaves can be determined by controlling lighting before leaf emergence, even if the spectral irradiance is changed later in growth. To produce optimum plant growth, both light quantity (DLI) and light quality (spectral irradiance) must be controlled.

The degree of cloudiness can rapidly vary from hour-to-hour, which not only compromises the overall amount of light, but also the light quality. FIG. 2 (prior art) shows the effect of clouds on the spectrum of sunlight, reported in Bartlett (1998). This data is normalized at 490 nm for the spectral content at each degree of cloudiness. As the number of clouds in the sky increases, there is an enhancement of the relative distribution of blue light versus red light. Bartlett (1998) also indicates that the albedo of the surrounding landscape can affect the light reflected from clouds, indicating that local measurement and correction is necessary. A global model or algorithm will not provide high quality control of the spectral distribution of light for plant growth.

There are a number of prior art attempts to control light spectra for different organisms, including Afshari (2012), US Patent Application Nos. 2008/0218995 and 2010/0287830A1. However, these focus on controlling the colour temperature perceived by the human eye, rather than optimizing for the needs of the growing organism.

In conventional greenhouses, there is a significant infrastructure overhead the growing plants. The resulting shadowing is different for different areas within the greenhouse, at different times, so a site-wide approach is insufficient. Moreover, different species requires different spectral irradiance for optimum growth, and different batches of the same species can require different spectral irradiance at different points in their lifecycle, such as triggering flowering or other seasonal changes.

### SUMMARY OF THE INVENTION

Aspects of the present invention allow optimum use of the most important resource in a greenhouse—sunlight—while simultaneously taking advantage of spectral irradiance engineering for greenhouses. In one embodiment, the present invention comprises a light source which monitors ambient spectral irradiance, determines a quantity and quality of supplemental light needed to achieve a target spectral irradiance, and controls a plurality of light-emitting diodes to produce the required supplemental light. The target spectral irradiance may be communicated to the lamp, and may vary with time of day, season or year, the plant species and plant's position in its life cycle, or some or all such variables in combination.

Therefore, in one aspect, the invention comprises a lighting system for use in a plant growing environment having a plurality of growing zones, comprising:

(a) a light source placed in each zone, comprising a plurality of LEDs and configured to output light having a controlled light intensity and/or spectral irradiance;

(b) at least one ambient light radiometer placed in each zone, configured to measure ambient light intensity and/or spectral irradiance received in the zone.

(c) a control system configured to receive the measured ambient light intensity and/or spectral irradiance from each radiometer, determine the difference between the measured ambient light intensity and/or spectral irradiance and a target light intensity and/or spectral irradiance, and cause the light source to emit supplemental light substantially equal to the difference so that the combined ambient light and supplemental light equals the target light intensity and/or spectral irradiance in each zone.

In a preferred embodiment, the growing environment may comprise a greenhouse, and each zone may comprise a single plant, or a grouping of plants.

In another aspect, the invention may comprise a light source comprising:

(a) a plurality of LEDs, configured to have a combined output which is adjustable for spectral irradiance and intensity;

(b) at least one radiometer for measuring ambient light intensity and/or spectral irradiance;

(c) a control system comprising a processor, configured to receive the measured ambient light intensity and/or spectral irradiance from the at least one radiometer, determine the difference between the measured ambient light intensity and/or spectral irradiance and a target light intensity and/or spectral irradiance, and cause the plurality of LEDs to emit supplemental light substantially equal to the difference so that the combined ambient light and supplemental light substantially equals the target spectral irradiance.

In one embodiment, some supplemental light may be diffuse and some supplemental light may be direct, and the ratio of diffuse and direct light can be changed.

In another aspect, the invention may comprise a method of optimizing plant growth, comprising the steps of:

(a) measuring the quantity and quality of ambient light received by a plant;

(b) determining the difference between the measured ambient light and an optimized target light intensity and/or spectral irradiance; and

(c) adjusting a light source to provide supplemental light in a quantity and quality to achieve the target light intensity and/or spectral irradiance.

In any embodiment, the target light intensity and/or spectral irradiance may be stable over time. Alternatively, the target irradiance may vary over time. The target intensity and/or irradiance may follow light intensity and/or irradiance received or known for a specific geographic location, which is remote from the actual geographic location. The target light intensity and/or irradiance may mimic the natural filtering of forest canopies, including the rapid variations induced by wind-blown leaves. The target light intensity and/or irradiance may mimic a natural daylight cycle and/or moonlight.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 (prior art): a plot showing typical variations in sunlight irradiance.

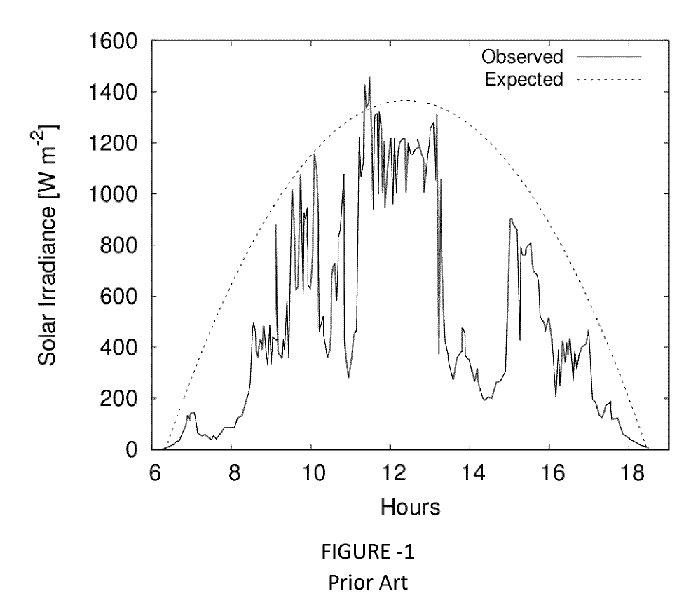

FIG. 2 (prior art): a plot showing the effect of cloud cover on sunlight spectral irradiance.

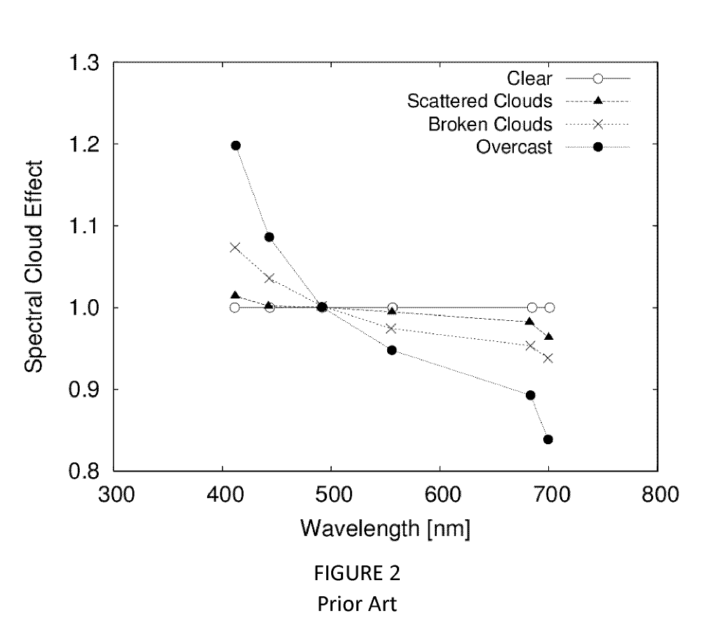

FIG. 3A is a schematic view of one embodiment of a multizone lighting system.

FIG. 3B is a schematic view of a control system for the lighting system of FIG. 3A.

FIG. 4: an exploded view of the ambient light radiometer.

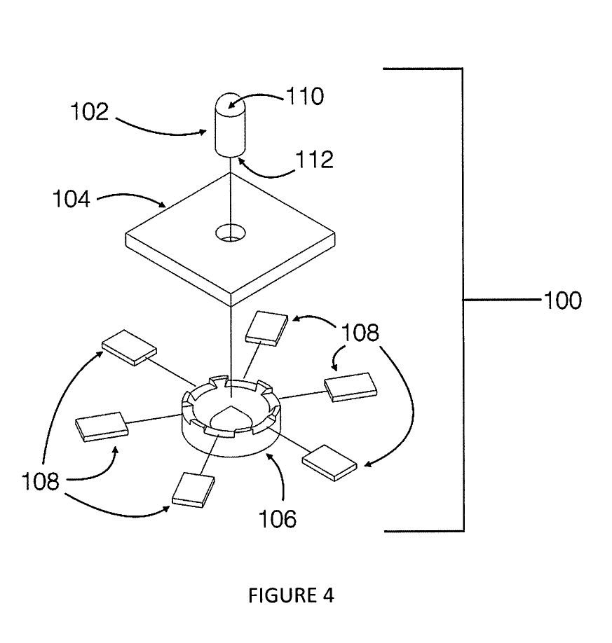

FIG. 5: cross-sectional view of the ambient light radiometer of FIG. 4.

FIG. 6: circuitry for a photodiode—transimpedance amplifier system.

FIG. 7: orthogonal view of one embodiment of a light source.

FIG. 8: another orthogonal view of the light source of FIG. 7.

FIG. 9: flowchart for the control algorithm for the light source.

### DETAILED DESCRIPTION

To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims. References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

As used herein, “light quantity” is a measure of the intensity of light in any given location at a given time. The quantity of light received over a length of time may be expressed as the light integral, and the quantity of light received during normal daylight hours may be expressed as the daily light integral or DLI.

As used herein, “spectral irradiance” refers to the quality of the light, in reference to its spectral distribution or composition.

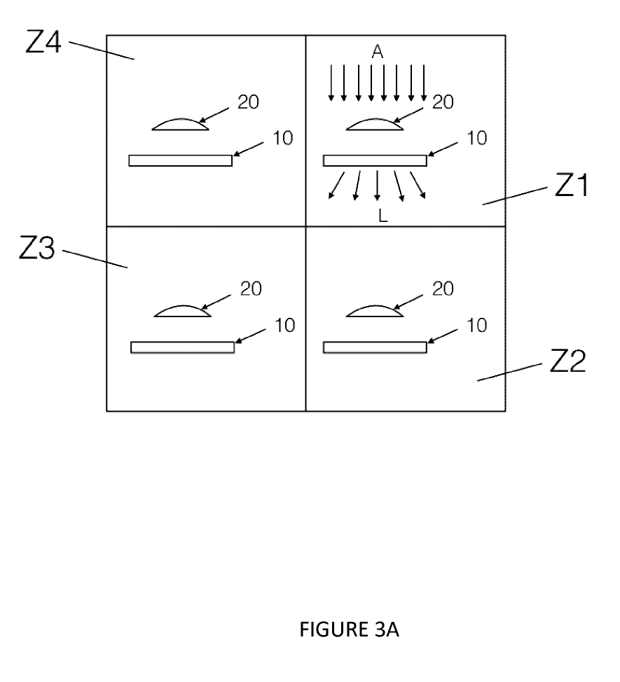

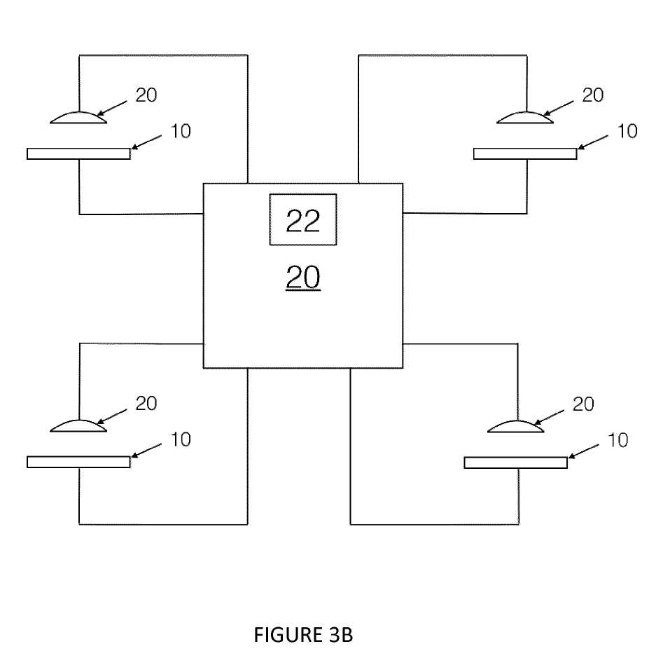

FIG. 3A shows a schematic of one embodiment of a lighting system of the present invention. A greenhouse or plant growing area (G) is divided into a plurality of zones (Z1-Z4). The number, size and configuration of the zones may be varied for different implementations. At least one light source (10) is provided in each zone, and at least one ambient light radiometer (20) is provided in each zone, preferably in close association with the light source (10). Each light source comprises a plurality of LEDs, the combined output (L) of which covers a broad light spectrum, preferably the spectrum which is required for healthy plant growth. For example, the spectrum may range from the ultraviolet (280-400 nm), through the visible light spectrum, to the near infrared (740-1000 nm). The LEDs may be controlled to output a range of overall light intensity and a spectrum of known spectral irradiance, ie. different wavelengths having different intensities. The plurality LEDs may include different LEDs tuned to different wavelengths to permit control of the spectral irradiance.

Each light source (10) is connected to, or comprises a control system (30) which is configured to cause the light source (10) to output light of specified intensity and/or spectral irradiance (distribution). The control system (30) receives data from the radiometer (20) to determine the quantity and/or quality of ambient light (A) received in the zone, compares the ambient light to the desired light conditions, both in terms of light quantity over a given period of time (DLI) and spectral irradiance. If the ambient light shows a deficiency in light quantity or quality, the light source may be controlled to output supplemental light (L) equal to the deficiency. Thus A+L equals the desired light conditions.

FIG. 3B shows a schematic representation of one embodiment of the control system (30). The desired light conditions may be separately determined and stored in a memory (32) which is integrated with the control system, or which is remotely located and accessed using standard wired or wireless communication protocols. Memory files may be uploaded and varied from time to time.

FIG. 3C shows an exploded view of one embodiment of an ambient light radiometer (100), comprised of an integrating rod (102) and printed circuit board (104), a biconical mirror (106) and at least one photodiode (108). The integrating rod (102) is preferably composed of BK7 glass, but may be composed of a different dielectric material. In this particular example, the integrating rod (102) has a rounded or hemispherical top (110) to increase the optical capture efficiency, but other shapes such as pyramidal, conical or flat tops may also be suitable. The relative size of the printed circuit board (104) depends on the number of circuit components required for its functionality.

The integrating rod (102) acts as a light mixer, through the physical mechanism of total internal reflection, such that light is conveyed down the optical mixing rod with multiple reflections. Total internal reflection can occur when light makes a transition from an optical material with a high index of refraction, n₁, to an optical material with a low index of refraction, n₂. Total internal reflection will occur when the incidence angle of a light ray, measured from the surface normal of the interface is greater than the critical angle:

$${θ}_{critical} = arcsin ( \frac{{n}_{2}}{{n}_{1}} ) \qquad ( 1 )$$

With internal reflection, light which enters the top of the rod (110) is transported through the rod (102), exiting at the bottom surface (112).

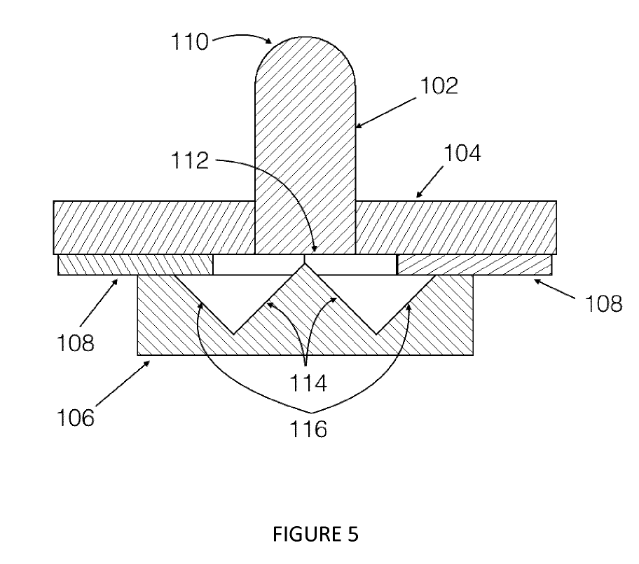

A cross-sectional view of the ambient light radiometer is shown in FIG. 5. In this embodiment, the radiometer is configured to deliver light to a plurality of photodiodes (108), arrayed radially around the radiometer. Light exiting the integrating rod through surface (112) strikes the biconical mirror (106), which will reflect the emitted light outwardly to the photodiodes 108. Light exiting surface (112) will first reflect off surface (114), then surface (116), reversing its direction while displacing it radially outwards. The active detector area of the photodiodes 108 is oriented such that light from mirror surface (116) will be detected and measured. If a plurality of photodiodes are provided, the photodiodes (108) may be separately sensitive to a different wavelength region, providing measurements of light intensity for each spectral region. For example, optical filters may be used to cover the active area, thereby restricting the measured light to a desired subset of the detected optical radiation. This may improve signal-to-noise for the photodiode output.

In the embodiment shown in FIG. 5, an array of 6 photodiodes is provided, where each photodiode is configured to be sensitive to different wavelength regions making up a band between about 400 nm to about 800 nm.

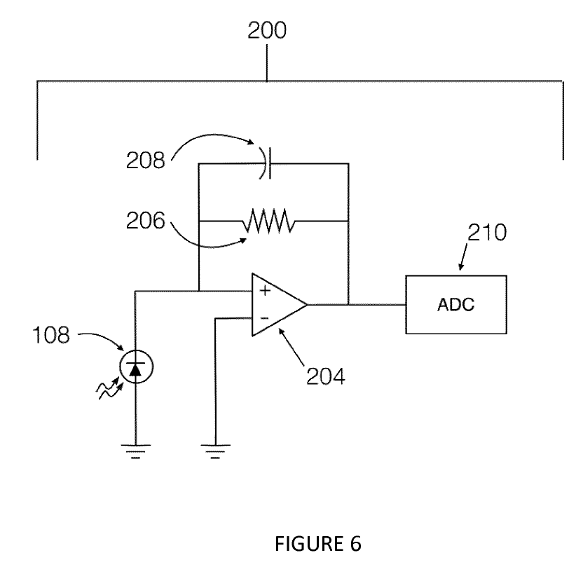

The photodiodes may comprise circuitry implementing a transimpedance amplifier (200). FIG. 6 shows one embodiment of a standard transimpedance amplifier, described in detail in Graeme (1996) Photodiode Amplifiers. The photodiode (108) converts photons to an electric current, which is amplified and converted to a voltage through a combination of an operational amplifier (204), resistor (206) and capacitor (208). The voltage from a photodiode transimpedance amplifier (200) is given by:

Vₒᵤₜ=A_{photodiode}G_{TIA}∫Φ(λ) [symbol] (λ)dλ, (2)

where Vₒᵤₜ is the output voltage, A_{photodiode} is the active area of the photodiode, G_{TIA} is the gain of the transimpedance amplifier, Φ is the spectral irradiance at the photodiode, R is the photodiode responsivity, and λ is wavelength. The voltage may then be converted to a digital signal for further processing and action (eg, by computer hardware and operating program or by analog circuitry) using analog-to-digital converter or ADC (210). In some cases, analog circuitry may be used instead of the ADC (210).

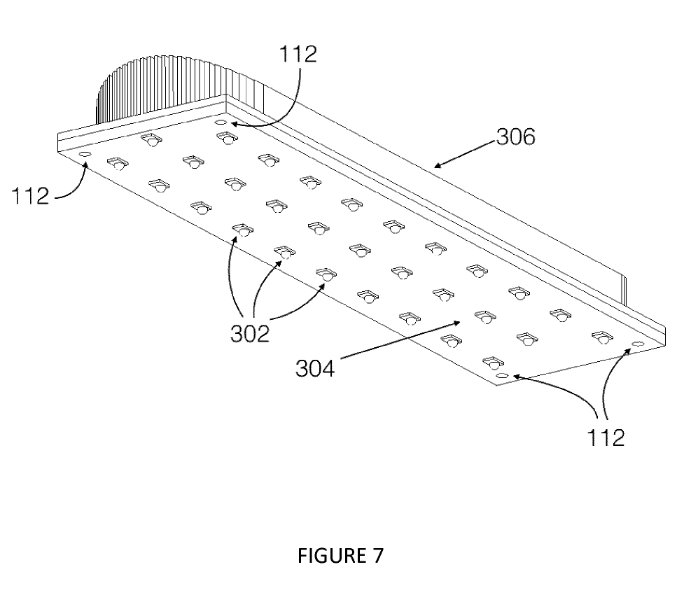

FIG. 7 shows an orthogonal view of a light source (10) comprising a plurality of individual LEDs (302), a printed circuit board (304), and a heat sink (306). Four ambient radiometers (100), which may be identical, are placed at the outside corners of the light source. In FIG. 7, each radiometer integrating rod bottom surface (112) is shown, mounted flush with the surface of printed circuit board (304), however, the mirror (106) and the photodiode (108) array are omitted for clarity. The number and spatial location of the LEDs (302) and radiometers (100) shown is an example of one possible configuration—other placements and numbers will be suitable as well. The LEDs (302) may be of different emission wavelengths to make up the desired bandwidth for the required target spectral irradiance. In some cases where a particular LED has insufficient power, a second LED at the same wavelength might be added to achieve the required power. The printed circuit board (304) may be comprised of FR4 or a metal based variant such as SA115 to improve heat shedding to the heat sink (306). The heatsink (306) dissipates heat from LED operation, and may be used with one or more fans to improve performance.

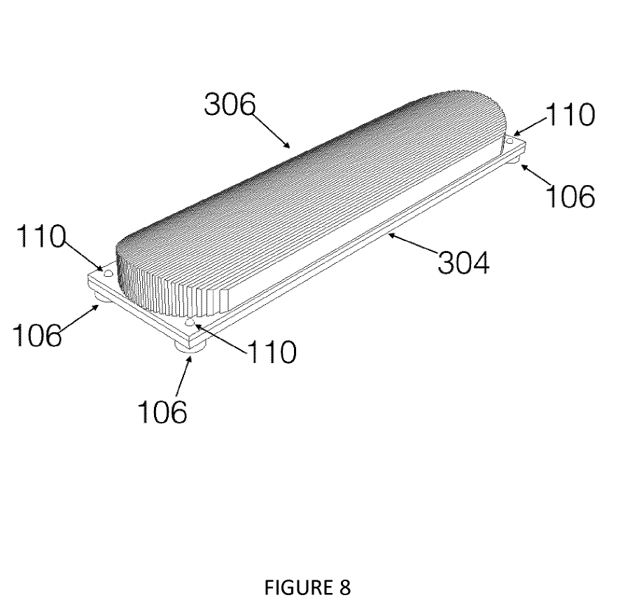

FIG. 8 shows an orthogonal view of the light source from the top, where the top surface of the ambient radiometers (110) are visible above the top surface of the heat sink 306. In this case, the fins of the heat sink (306) have been cut away in a smooth curve to allow ambient light to interact with the top (110) of the integrating rods (102). Biconical mirrors (106) are placed on the underside of the light source.

In one embodiment, the intensity and spectrum measured by each ambient light radiometer (100) may be read instantaneously, averaged over a given time period, or combined in different algorithms to determine the average spectral irradiance observed by the light source. These calculations may be performed with processors onboard the light source itself to allow the lamp to react to local conditions.

In one embodiment, the control system will receive data for each zone, which data indicates the quantity of ambient light and its spectral irradiance received in the zone. The system will then compare that to a desired spectral irradiance and quantity of light for that zone. If either measure indicates a deficiency, either in overall quantity, or at a specific wavelength band, then the light source may be turned on and caused to emit light which makes up the deficiency. As at least one light source and at least one associated radiometer is used for each zone, local control of lighting conditions may be implemented. Zones may be configured as small as encompassing a single plant, or groupings of plants. In this way, light may be optimized for all plants and areas in an agricultural operation, such as in a large greenhouse.

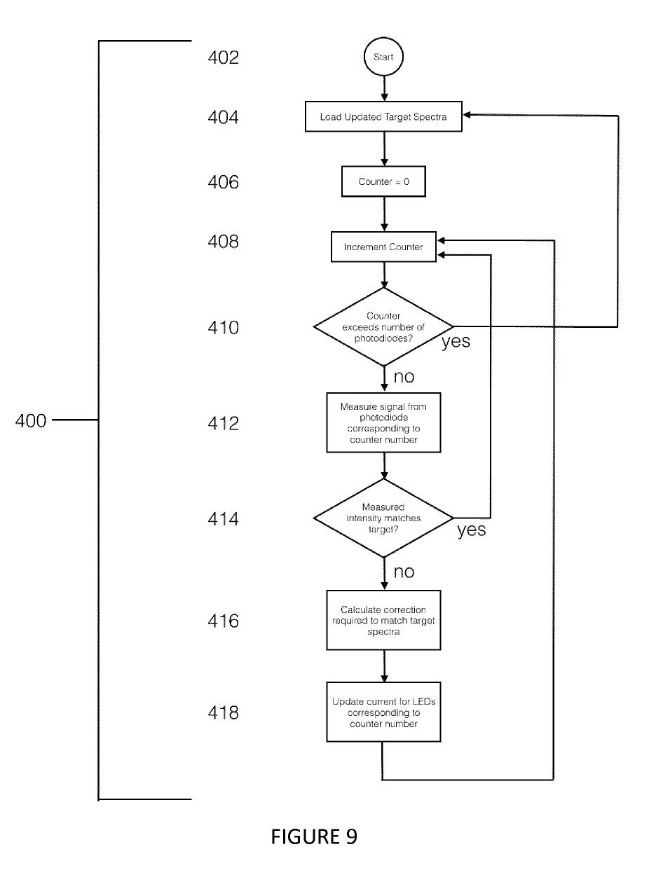

FIG. 9 is an operational flow chart describing one specific embodiment of a control algorithm (400) for a light source (10) having a radiometer with multiple photodiodes. When the light source (10) is turned on, operation begins with startup routines, in step 402, necessary to turn on the LEDs and any onboard processors. Once complete, the light source will load, in step 404, the most recent or desired target light conditions available. This target light conditions may be transmitted from an external source across a wireless or wired connection, or may be calculated by an onboard computer based on the current time and an operator selected preference.

Once loaded, each photodiode is queried sequentially, using an internal counter, which is set to zero in step 406. With a reading obtained from each photodiode, the counter is subsequently incremented in step 408, and compared to the total number of photodiodes (108) on the grow lamp in step 410. Once a reading has been obtained from each photodiode, ie. the counter equals the number of photodiodes, the control algorithm will return to step 404 and load an updated spectra.

If the measured intensity for an individual photodiode matches the target value from the spectra loaded in step 404, the next step is to move to the next photodiode and increment the counter in step 408. If the measured value does not match the spectra loaded in step 404, the correction required to match the value is calculated in step 416. This correction is communicated to the control circuitry for the LED or LEDs corresponding to the wavelength region measured by the photodiode at step 418. Once this communication has been made, the control algorithm will move to the next photodiode (increment the counter at step 408).

### Definitions and Interpretation

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated.

The corresponding structures, materials, acts, and equivalents of all means or steps plus function elements in the claims appended to this specification are intended to include any structure, material, or act for performing the function in combination with other claimed elements as specifically claimed.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. “Communicatively coupled” refers to coupling of components such that these components are able to communicate with one another through, for example, wired, wireless or other communications media. The term “communicatively coupled” or “communicatively coupling” includes, but is not limited to, communicating electronic control signals by which one element may direct or control another. The term “configured to” describes hardware, software or a combination of hardware and software that is adapted to, set up, arranged, built, composed, constructed, designed or that has any combination of these characteristics to carry out a given function. The term “adapted” or “configured” describes hardware, software or a combination of hardware and software that is capable of, able to accommodate, to make, or that is suitable to carry out a given function.

The terms “computer” or “processor” or “control system” describe examples of a suitably configured processing system adapted to implement one or more examples herein. Any suitably configured processing system is similarly able to be used by examples herein, for example and not for limitation, a personal computer, a laptop computer, a tablet computer, a smart phone, a personal digital assistant, a workstation, or the like. A processing system may include one or more processing systems or processors. A processing system can be realized in a centralized fashion in one processing system or in a distributed fashion where different elements are spread across several interconnected processing systems.

The terms “computing system”, “computer system”, and “personal computing system”, describe a processing system that includes a user interface and which is suitably configured and adapted to implement one or more examples of the present disclosure.

The term “portable electronic device” is intended to broadly cover many different types of electronic devices that are portable or that can be transported between locations by a user. For example, and not for any limitation, a portable electronic device can include any one or a combination of the following: a wireless communication device, a laptop personal computer, a notebook computer, a desktop computer, a personal computer, a smart phone, a Personal Digital Assistant, a tablet computer, gaming units, remote controller units, and other handheld electronic devices that can be carried on one's person.

The corresponding structures, materials, acts, and equivalents of all means or step plus function elements in the claims below are intended to include any structure, material, or act for performing the function in combination with other claimed elements as specifically claimed. The description herein has been presented for purposes of illustration and description, but is not intended to be exhaustive or limited to the examples in the form disclosed. Many modifications and variations will be apparent to those of ordinary skill in the art without departing from the scope and spirit of the examples presented or claimed. The disclosed examples were chosen and described in order to best explain the principles of the examples and the practical application, and to enable others of ordinary skill in the art to understand the various examples with various modifications as are suited to the particular use contemplated. It is intended that the appended claims below cover any and all such applications, modifications, and variations within the scope of the examples.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described. In other words, any element or feature may be combined with any other element or feature in different embodiments, unless there is an obvious or inherent incompatibility between the two, or it is specifically excluded.

### REFERENCES

Any document referenced in the description above and the following references are incorporated by reference herein, where permitted, as though reproduced herein in their entirety.
Afshari et al. (2012) American Control Conference, 3663-3668
Bartlett et al. (1998) J. Geophysical Research 103, 31017-31031
Bula et al. (1991) HortScience Vol. 26, 203-205
Eskins (1996) J. Plant Physiology 147, 709-713
Fain et al. (1964) Applied Optics 3, pp 1389-1395
Fain et al. (2006) JLVE
Folta et al. (2005) BMC Plant Biology 5-17 (
Gu et al. (2001) Agricultural and Forest Meteorology 106, 117-129
Warrington (1976) Agricultural Meteorology 16, 247-262

What is claimed is:

1. A lighting system for use in a plant growing environment having a plurality of growing zones, comprising:
(a) a light source placed in each zone, comprising a plurality of LEDs and configured to output light having a controlled spectral irradiance;
(b) at least one ambient light radiometer placed in each zone, configured to measure ambient spectral irradiance received in the zone; and
(c) a control system configured to receive the measured ambient spectral irradiance from each radiometer, determine the difference between the measured ambient spectral irradiance and a target spectral irradiance, and cause the light source to emit supplemental light substantially equal to the difference so that the combined ambient light and supplemental light equals the target spectral irradiance in each zone.

2. The system of claim 1 wherein the growing environment may comprise a greenhouse, and each zone may comprise a single plant, or a grouping of plants.

3. A light source comprising:
(a) a plurality of LEDs, configured to have a combined output which is adjustable for frequency and intensity;
(b) at least one radiometer for measuring ambient light;
(c) a control system comprising a processor, configured to receive the measured ambient spectral irradiance from the at least one radiometer, determine the difference between the measured ambient spectral irradiance and a target spectral irradiance, and cause the plurality of LEDs to emit supplemental light substantially equal to the difference so that the combined ambient light and supplemental light substantially equals the target spectral irradiance.

4. The light source of claim 3 wherein the at least one radiometer comprises a plurality of photodiodes, each sensitive to a different light wavelength region.

5. The light source of claim 4 wherein each photodiode comprises an optical filter which restricts light reaching the photodiode to a wavelength region.

6. The light source of claim 3 wherein the plurality of LEDs comprises individual LEDs which emit light at different wavelengths and are which are separately controllable for intensity.

7. A method of optimizing plant growth, comprising the steps of:
(a) measuring the quantity and quality of ambient light received by a plant over a given time period;
(b) determining the difference between the measured ambient light and an optimized target spectral irradiance; and
(b) adjusting a light source to provide supplemental light in a quantity and quality over the time period to achieve the target spectral irradiance.

8. The method of claim 7 wherein plant growth is separately optimized in at least two adjacent zones, wherein each zone may comprise a single plant, or a small grouping of plants.
